(19) United States
(12) Patent Application Publication
(10) Pub. No.: US 2025/0270788 A1
(43) Pub. Date: Aug. 28, 2025

(54) UTILITY VEHICLE OPERATOR CAB ROOF

(71) Applicant: MANITOU EQUIPMENT AMERICA, LLC, West Bend, WI (US)

(72) Inventor: Alexander PROKOPOWICZ, West Bend, WI (US)

(21) Appl. No.: 18/856,510

(22) PCT Filed: Apr. 12, 2023
(86) PCT No.: PCT/US2023/018343

§ 371 Date: Oct. 11, 2024

Related U.S. Application Data
(60) Provisional application No. 63/362,847, filed on Apr. 12, 2022.

(51) Int. Cl. E02F 9/16; B62D 25/07

(52) U.S. Cl. CPC E02F 9/163; B62D 25/07

(57) ABSTRACT

A utility vehicle including an operator cab having a front end and a back end, the operator cab including a cab roof having an upper surface. The upper surface includes a recessed portion, the recessed portion including a planar surface. The planar surface is positioned at an angle with respect to the upper surface such that the planar surface slopes downward and away from the upper surface as the second planar surface extends from the back end to the front end of the operator cab.

### CROSS-REFERENCE TO RELATED APPLICATIONS

This application claims priority under 35 U.S.C. § 119 to U.S. Provisional Patent Application No. 63/362,847, filed Apr. 12, 2022, the contents of which are incorporated by reference herein in its entirety.

### BACKGROUND

Utility vehicles, such as loaders, telehandlers, forklifts, and the like are useful in a variety of covered environments as well as outdoor environments. Some conventional utility vehicles include a movement mechanism such as an engine coupled to wheels or tracks. Some utility vehicles include an operator cab in which a vehicle operator can manipulate various control mechanisms to control vehicle movement and/or working attachments such as a bucket, auger, graders, blades, mulchers, and the like. Because utility vehicles are frequently used in a variety of outdoor environments, many utility vehicles require protection from the elements. In particular, the operator cab can include a covering, such as a roof, to shield the vehicle operator from rain, snow, or falling debris that is generated as a result of using the utility vehicle. In many instances, it is useful to provide a line of sight through the roof of the operator cab because the utility vehicle is being used to lift objects up above the roof of the operator cab, lower objects down from above the roof of the operator cab, or manipulate dirt, sand, gravel or construction materials above the roof of the operator cab.

Accordingly, some utility vehicles include a transparent or translucent window disposed in at least a portion of the operator cab roof such that the operator can see through the roof for controlling the working attachment(s) and can view environmental conditions adjacent the cab roof. Utility vehicles are frequently used in environments that work with or produce various forms of debris that can fall onto the roof of the operator cab. Conventional operator cab roofs are substantially flat and shaped perpendicularly to the force of gravity when the utility vehicle is at rest on level ground. Accordingly, in outdoor applications, water and debris can collect on top of the operator cab roof, often obstructing the operator's line of sight through the cab roof. In some instances, when water that has collected on top of the operator cab roof evaporates, the water can leave a layer of mineral deposits. Therefore, it would be useful to provide an improved operator cab design that prevents the buildup of debris and mineral deposits on top of the operator cab roof.

### SUMMARY

Some embodiments provide a utility vehicle including an operator cab having a front end and a back end. The operator cab can include a cab roof having an upper surface extending from the front end to the back end. The upper surface can include a first planar surface and a recessed portion, the recessed portion including a second planar surface. The second planar surface can be positioned at an angle with respect to the first planar surface such that the second planar surface slopes downward and away from the upper surface as the planar surface extends from the back end to the front end of the operator cab.

In some forms, the recessed portion includes an opening and a transparent pane covering the opening, the transparent pane being angled with respect to the first planar surface such that the transparent pane extends downward and away from the first planar surface as the transparent pane extends from the back end to the front end of the operator cab. The recessed portion can form a u-shaped channel in the upper surface of the cab roof, the u-shaped channel extending to a front-most edge of the upper surface. The upper surface can include a back planar surface that extends downward and away from the first planar surface as the back planar surface extends from an edge of the first planar surface toward the back end of the operator cab. The upper surface can include a grid structure that separates the opening into a plurality of openings. The upper surface can include two lateral walls that extend from the first planar surface to the second planar surface to form the sides of the u-shaped channel. The transparent pane can be bonded to a portion of the recessed portion.

Some embodiments provide a utility vehicle including a vehicle body and an operator cab. The vehicle body has a front end and a rear end. The operator cab can include a cab roof having an upper surface. The upper surface can include a first planar surface and a second planar surface. The second planar surface can be recessed into the first planar surface. The second planar surface can be slanted downward toward the front end such that when the utility vehicle is positioned on a level surface, liquid falling onto the second planar surface is directed by the second planar surface toward the front end of the vehicle body.

In some forms, the second planar surface includes an opening and a transparent pane covers the opening. The upper surface can further include a back planar surface that extends from an edge of the first planar surface toward the rear end, the back planar surface being slanted downward as it extends from the edge of the first planar surface toward the rear end such that when the utility vehicle is positioned on a level surface, liquid falling on to the back planar surface is directed toward the engine compartment. An angle between the first planar surface and the second planar surface can be between about 3 degrees to about 10 degrees. The operator cab can include a front opening and a crossmember at the top of the front opening, the cross member including a length dimension and a width dimension, wherein the ratio of the length dimension to the width dimension is about 7 to about 1 or greater. The second planar surface can include a grid structure that is positioned beneath, and adjacent, a transparent pane.

Some embodiments provide a utility vehicle including a vehicle body and an operator cab. The vehicle body can include a front end, a back end, and two lateral sides. The operator cab roof can include an upper surface with a first planar surface and a second planar surface. The second planar surface can include a lip on an edge of the second planar surface disposed adjacent the front end of the vehicle body. The lip can include a raised center ridge positioned at a centerline of the vehicle body, the centerline extending from the front end to the back end of the vehicle body. The raised center ridge can have a plurality of lateral surfaces that are angled downward as the lateral surfaces extend away from the center ridge toward the lateral sides of the vehicle body.

In some forms, the lip is chamfered toward the front end of the vehicle body. The lateral surfaces can be substantially triangular and share an edge at the raised center ridge. The second planar surface and a plurality of lateral walls can form a u-shaped channel in the upper surface of the cab roof, and at least one of the lateral surfaces and at least one of the plurality of lateral walls can form a triangular channel. The second planar surface can include an opening, a grid structure, and a transparent pane positioned over the grid structure and covering the opening, the transparent pane being angled with respect to the upper surface such that the transparent pane extends downward and away from the upper surface as the transparent pane extends from the back end to the front end of the vehicle body. The triangular channel can taper in a direction toward at least one of the lateral sides of the vehicle body and toward the front end of the vehicle body. The utility vehicle can include two triangular channels, a first triangular channel formed by a first lateral surface and a first lateral wall and a second triangular channel formed by a second lateral surface and a second lateral wall.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a partial top isometric view of a utility vehicle according to an embodiment;

FIG. 2 is a partial front isometric view of the utility vehicle of FIG. 1;

FIG. 3 is a partial cross-sectional view of the utility vehicle of FIG. 1 taken along line X-X of FIG. 1;

FIG. 4 is a partial front isometric view of the utility vehicle of FIG. 1;

FIG. 5 is a partial top plan view of the utility vehicle of FIG. 1;

FIG. 6 is a partial view of a cab roof of the utility vehicle of FIG. 1 taken from inside an operator cab of the utility vehicle facing toward a front opening of the operator cab;

FIG. 7 is a partial top plan view of the utility vehicle of FIG. 1; and

FIG. 8 illustrates a partial top plan view of an alternate form of the utility vehicle of FIG. 1 including a grid structure.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

As explained above, it would be useful to provide an improved utility vehicle operator cab. Because conventional operator cab roofs are shaped substantially perpendicular to the force of gravity (when the vehicle is resting on a level surface), water and debris can collect on top of the operator cab roof, obstructing the operator view through the roof of a vehicle. Embodiments described herein are designed to prevent the collection and retention of matter on top of the operator cab roof of utility vehicle as well as provide other benefits as described herein.

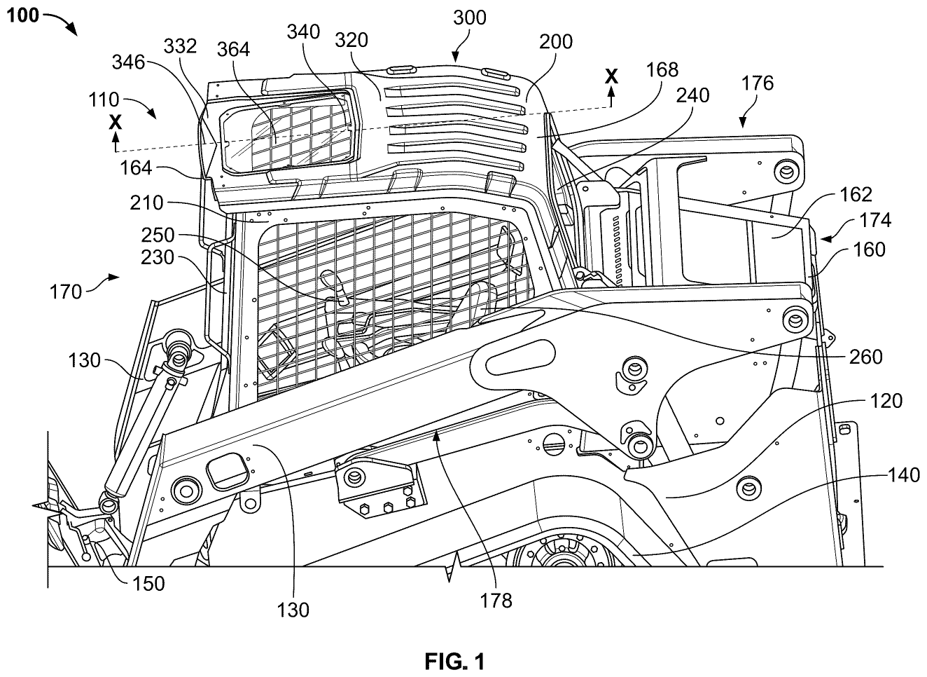

FIG. 1 illustrates a utility vehicle 100 with an operator cab 110 according to one embodiment. The utility vehicle 100 includes a vehicle body 120, a pair of lift arms 130, the operator cab 110, a pair of tracks 140, a utility attachment 150, and an engine compartment 160. The vehicle body 120 has a front end 170, a rear end 174, and lateral sides 176, 178. The engine compartment 160 can include an engine cover 162 disposed over the top of the engine of the utility vehicle 100. The pair of lift arms 130 extend along the lateral sides 176, 178 of the vehicle body 120. The operator cab 110 is positioned between the pair of lift arms 130, between the front end 170 and the rear end 174 of the vehicle body 120, and includes a corresponding operator cab front end 164 and back end 168. The engine compartment 160 is disposed behind the operator cab 110 toward the rear end 174 of the vehicle body 120. In some forms, the lift arms 130 are coupled to the vehicle body 120 adjacent to the sides of the engine compartment 160. In some forms, the utility vehicle 100 includes only a single lift arm 130. The single lift arm 130 can be coupled to the vehicle body 120 in front of the operator cab 110 toward the front end 170 or behind the operator cab 110 toward the rear end 174. In some forms, the single lift arm 130 can be coupled to the vehicle body 120 adjacent to the operator cab 110 toward one of the lateral sides 176, 178 and positioned to one side of a centerline X-X extending from the front end 170 to the rear end 174 while the operator cab 110 is positioned to the other side of the centerline X-X. In some forms, the single lift arm 130 can be coupled to the vehicle body 120 adjacent to, and in front of, (or partially in front of) the operator cab 110, or adjacent to, and behind, (or partially behind) the operator cab 110. In some forms, the engine compartment 160 is located adjacent the operator cab 110 toward one of the lateral sides 176, 178. In some forms, the engine compartment 160 is located adjacent to, and in front of, (or partially in front of) the operator cab 110, or adjacent to, and behind, (or partially behind) the operator cab 110.

The utility attachment 150 can be provided in the form of an auger, backhoe, bale mover, blade, boom lift, breaker, broom, bucket, chipper, concrete tool, grader blade, grappler, land leveler, log splitter, material unroller, mower, mulcher, pallet fork, rake, rock wheel, roto tiller, scarifier, scrapper, silage defacer, snow blower, snow push, sod unroller, spreader, stump grinder, stump remover, tree handler, trencher, and the like. It is further understood that although a pair of tracks 140 is illustrated with the utility vehicle 100, other mechanical forms of movement can be provided, such as a set of wheels. Further, although an engine compartment 160 is described for utility vehicle 100, other forms of vehicle power can be provided. For example, the utility vehicle 100 can be battery powered or powered through other electrical means. Although the utility vehicle 100 is depicted in FIG. 1 as a compact loader, it is to be understood that the operator cab 110 can also be provided on numerous other utility vehicles such as telescopic handlers, vertical lifts, forklifts, or other construction, agricultural, or warehousing vehicles.

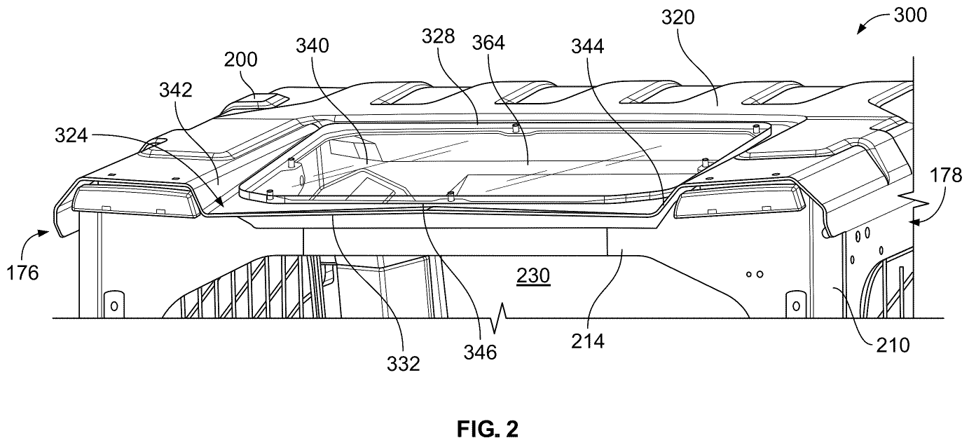

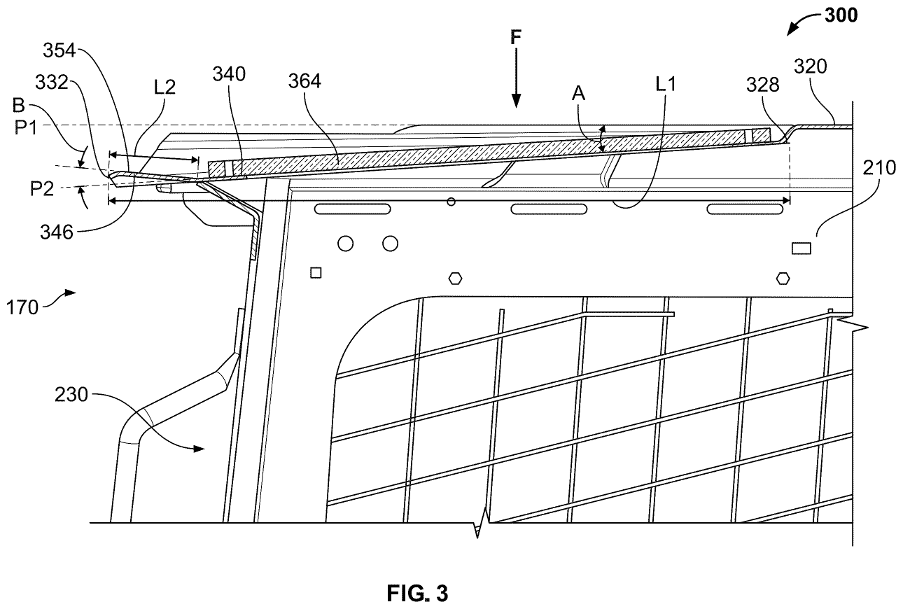

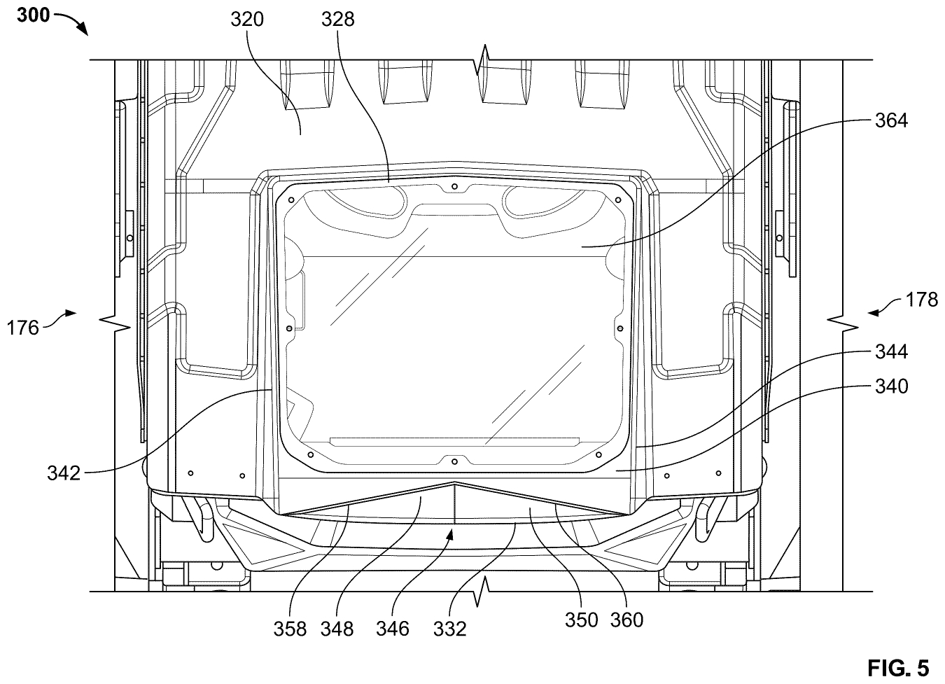

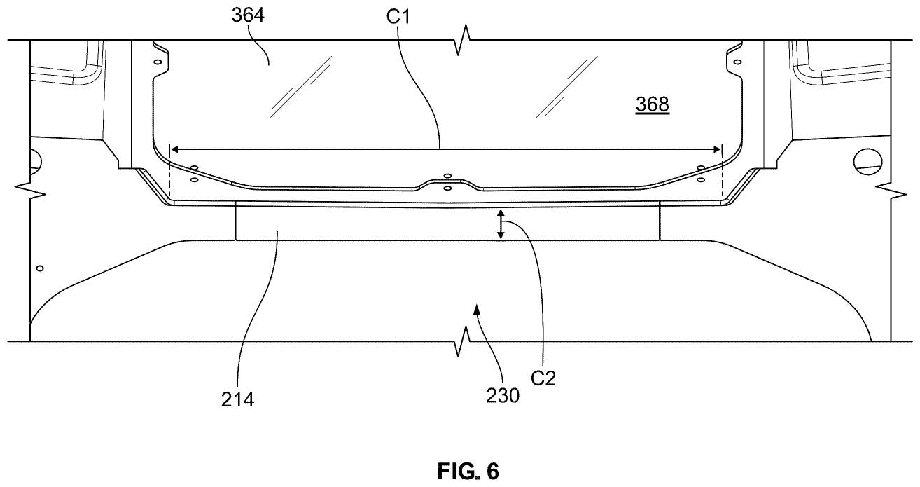

In some embodiments, the operator cab 110 includes a cab roof 200, a frame 210 with a crossmember 214 (see FIGS. 2 and 6), a front opening 230, and a rear window 240. Inside the operator cab 110 is a vehicle control unit 250 and an operator seat 260. As illustrated in FIGS. 2-5, the cab roof 200 includes an upper surface 300 having at least a first planar surface 320 and a second planar surface 340. Referring further to FIG. 3, the first planar surface 320 is disposed along a first plane P1, and the second planar surface 340 is disposed along a second plane P2, and P2 is disposed at an acute angle A to P1. When the utility vehicle 100 is resting on a level surface, P1 is substantially parallel to the level surface. For the purposes of this application, a level surface is a surface that is substantially perpendicular to the force of gravity.

A vector F is illustrated in FIG. 3 to represent the direction of the force of gravity. In some forms, when the utility vehicle 100 is resting on a level surface, P1 forms an acute angle with the level surface, and P1 is slanted slightly downward toward the front end 170 or, alternatively, P1 is slanted slightly downward toward the rear end 174. In some forms, when the utility vehicle 100 is resting on a level surface, both P1 and P2 are slanted downwardly at an angle from the level surface toward the front end 170 of the vehicle body 120, and P2 is slanted at a larger angle than P1. In some embodiments, the upper surface 300 comprises numerous other planar surfaces and geometries in addition to the first planar surface 320 and the second planar surface 340. For example, the upper surface 300 can include a back planar surface that extends from an edge of the first planar surface 320 toward the rear end 174 and is slanted downward as it extends from the edge of the first planar surface 320 toward the rear end 174.

Referring further to FIGS. 2 and 3, the second planar surface 340 can be recessed into the upper surface 300 and/or the first planar surface 320, providing a recessed portion of the upper surface 300. The second planar surface 340 is slanted downward from the first planar surface 320 toward the front end 170 of the vehicle body 120 as the second planar surface 340 extends from the back end 168 of the operator cab 110 to the front end 164 of the operator cab 110. In some embodiments, the angle A between the first planar surface 320 and the second planar surface 340 is between about 0.1 degree to about 1 degree. In some embodiments, the angle A is between about 1 degree to about 3 degrees. In some embodiments, the angle A is between about 3 degrees to about 5 degrees. In some embodiments, the angle A is between about 5 degrees to about 10 degrees. In some embodiments, the angle A is between about 10 degrees to about 30 degrees. In some embodiments the angle A is greater than about 3 degrees.

As a result of the second planar surface 340 being recessed into the upper surface 300, a u-shaped channel 324 is formed into the cab roof 200. The “U” shape of the u-shaped channel 324 is formed via the second planar surface 340 and lateral walls 342, 344 of the upper surface 300 (best shown in FIG. 2). In some forms, the lateral walls 342, 344 are substantially perpendicular to the second planar surface 340 and the first planar surface 320. In some forms, the lateral walls 342, 344 slope at an angle from the first planar surface 320 to the second planar surface 340. The lateral walls 342, 344 can slope inward toward each other as the lateral walls 342, 344 extend from the first planar surface 320 toward the second planar surface 340. Alternatively, in some forms, the lateral walls 342, 344 slope outward and away from each other toward the respective lateral side 176, 178 of the utility vehicle 100 as the lateral walls 342, 344 extend from the first planar surface 320 toward the second planar surface 340. The u-shaped channel 324 begins at a back-most edge 328 of the second planar surface 340 (where the second planar surface 340 begins the recessed portion into the upper surface 300) and extends up to a front-most edge 332 of the second planar surface 340. Accordingly, the second planar surface 340 and the u-shaped channel 324 are sloped downward toward the front end 170 of the vehicle body 120 and the front end 164 of the operator cab 110 from the back-most edge 328 all the way to the front-most edge 332 of the second planar surface 340.

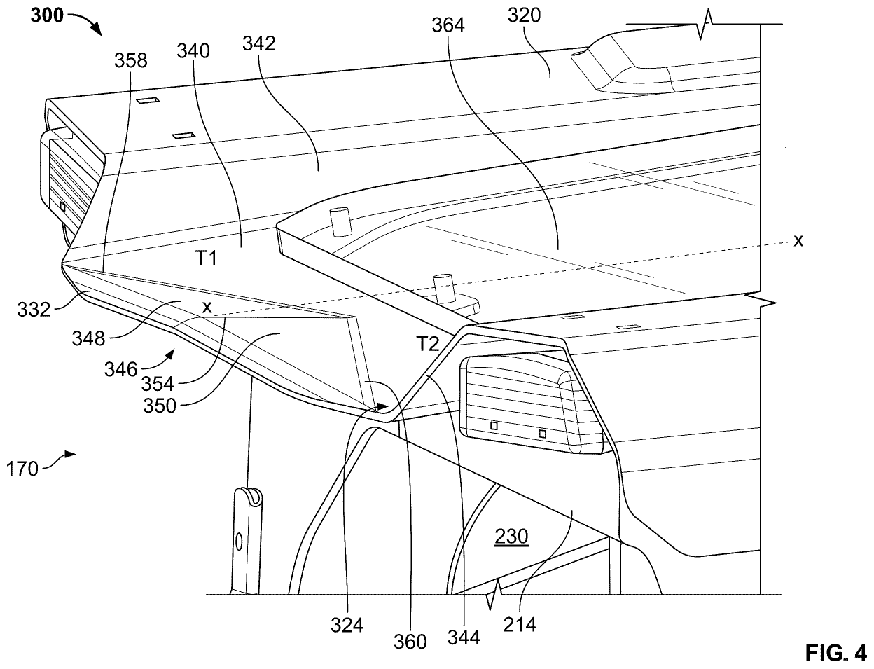

As best shown in FIG. 4, the second planar surface 340 includes a raised lip structure 346 extending along the front-most edge 332 of the second planar surface 340. The raised lip structure 346 includes lateral surfaces 348, 350 and a raised center ridge 354, which is positioned along the centerline X-X of the vehicle body 120, the centerline X-X splitting the vehicle into right and left halves. The lateral surfaces 348, 350 are adjoined at the raised center ridge 354 and are angled downward as the lateral surfaces 348, 350 extend away from the raised center ridge 354 toward the lateral sides 176, 178 of the vehicle body 120. The lateral surfaces 348, 350 can be triangular in shape, and the lateral surfaces 348, 350 can share the raised center ridge 354 as one side of each of the lateral surfaces 348, 350. The lateral surfaces 348, 350 can be sized and shaped as congruent triangles that are reflected across the raised center ridge 354. The hypotenuses 358, 360 of each of the lateral surfaces 348, 350, respectively, form two triangular channels T1 and T2 with the respective adjacent lateral wall 342, 344 of the u-shaped channel 324. Accordingly, the lateral wall 342 and the hypotenuse 358 of the lateral surface 348 form the triangular channel T1, and the lateral wall 344 and the hypotenuse 360 of the lateral surface 350 form the triangular channel T2. The triangular channels T1 and T2 taper as they extend from the rear end 174 to the front end 170 of the vehicle body 120. Also, the triangular channels T1 and T2 are provided as sub-channels within the u-shaped channel 324 and are formed at the end of the u-shaped channel 324 to direct fluid away from the raised center ridge 354 as will be described further below.

Referring again to FIG. 3, the raised center ridge 354 extends upward from the second planar surface 340 at an angle B. In some forms, the raised center ridge 354 is parallel with the plane P1 and the first planar surface 320. In some forms, the raised center ridge 354 is angled upward with respect to the plane P1 as the raised center ridge 354 extends toward the front-most edge 332. Accordingly, when the utility vehicle 100 is resting on a level surface, the raised center ridge 354 forms an acute angle with the level surface and is slanted slightly upward as it extends toward the front end 170. In some forms, the angle A is equal to the angle B. In some forms, the angle A is greater than the angle B. In some forms, the angle A is less than the angle B. In some forms, the raised lip structure 346 is chamfered along the front-most edge 332.

The second planar surface 340 is defined by a length L1, and the raised center ridge 354 is defined by a length L2. In some forms, the length L1 is about 7 to about 8 times longer than L2. In some forms, the raised center ridge 354 extends along the entire length L1 of the second planar surface 340. In some forms, L1 is about 2 times the length of L2. In some forms, the length L2 and the angle B are configured such that the raised center ridge 354 extends above the plane P1 at the front-most edge 332.

As illustrated in FIGS. 1, 2, 4, 5 and 7, in some embodiments, the second planar surface 340 includes a roof opening 368 that extends through at least part of the second planar surface 340. In some forms, the roof opening 368 is covered by an at least partially, or entirely, transparent pane 364 to provide a skylight for the cab roof 200. The transparent pane 364 can be provided in the form of a glass, plastic, or another transparent or translucent material, and can be coupled to the second planar surface 340 via chemical fasteners such as adhesive bonding (e.g., epoxy, glue, or any other suitable adhesive bonding), or mechanical fasteners such as threaded screws, bolts, or studs. In some forms, the transparent pane 364 is between 0.15 inches and 0.25 inches in a thickness dimension. In some forms, the transparent pane 364 is between 0.2 inches and 0.3 inches in a thickness dimension. In some forms, the transparent pane 364 is between 0.25 inches and 0.35 inches in a thickness dimension. In some forms, the transparent pane 364 is between 0.3 inches and 0.4 inches in a thickness dimension. In some forms, the transparent pane 364 is chamfered on any or all of the edges of the transparent pane 364.

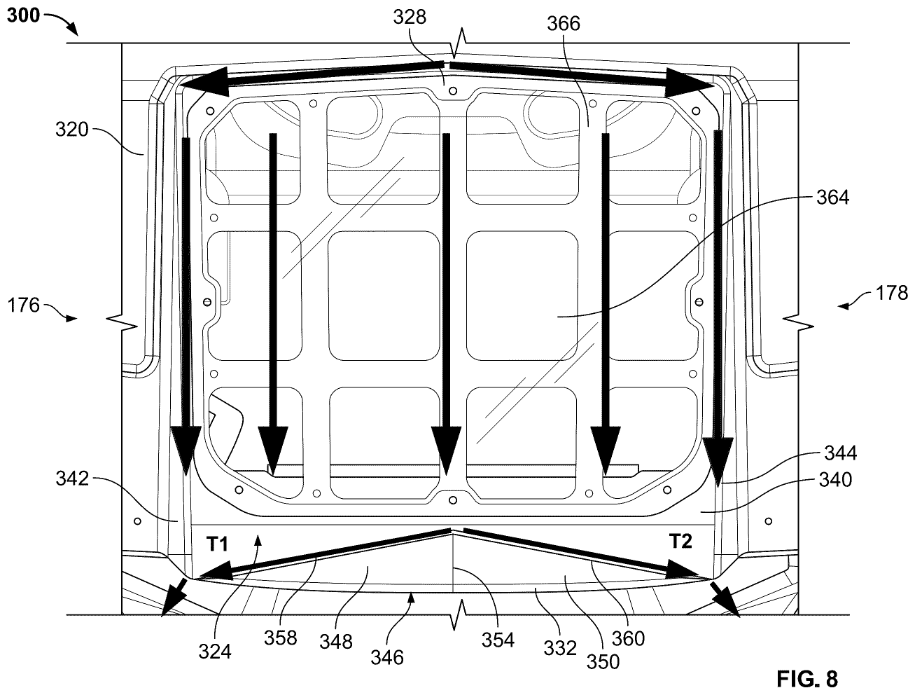

In some forms, the cab roof 200 can alternatively include a grid structure 366. For example, FIG. 8 illustrates a partial top plan view of the utility vehicle 100 provided with the grid structure 366. The grid structure 366 can separate the roof opening 368 into a plurality of openings 368. The second planar surface 340 may include the grid structure 366 positioned beneath, aligned with, and adjacent the transparent pane 364. In some forms, the grid structure 366 may form a continuous portion of the second planar surface 340 and extend from the back-most edge 328 of the second planar surface 340 to the front-most edge 332 of the second planar surface 340, and from the lateral wall 342 to the lateral wall 344. In other forms, the grid structure 366 may be fastened to portions of the second planar surface 340 via chemical fastening or mechanical fastening means. In some forms, the grid structure 366 may be chamfered on any or all of the edges of the grid structure 366. In some forms, the grid structure 366 may comprise a metallic material such as steel. In some forms, the grid structure 366 may form a grid pattern of 3×3, 3×4, 4×3, or 4×4.

One benefit of including the transparent pane 364 with the angled second planar surface 340 is that the crossmember 214 has a higher length to width ratio than if the second planar surface 340 was not angled with respect to the upper surface 300. As shown in FIG. 6, the length C1 of the crossmember 214 is longer than the width C2 of the crossmember 214. In some forms, the ratio of the length C1 to the width C2 is about 10 to about 1 or greater. In some forms, the ratio of the length C1 to the width C2 is between about 8 to about 1 to about 10 to about 1. In some forms, the ratio of the length C1 to the width C2 is about 7 to about 1 or greater.

In use, the aforementioned angles and dimensions of the first planar surface 320, the second planar surface 340, and the raised lip structure 346 help to divert fluid (or other debris) toward the front end 170 of the utility vehicle 100 and away from the front opening 230 of the operator cab 110 toward the lateral sides 176, 178 of the utility vehicle 100. Thus, fluid and debris do not accumulate onto of the cab roof 200, and fluid and debris are directed away from entering the operator cab 110 through the front opening 230.

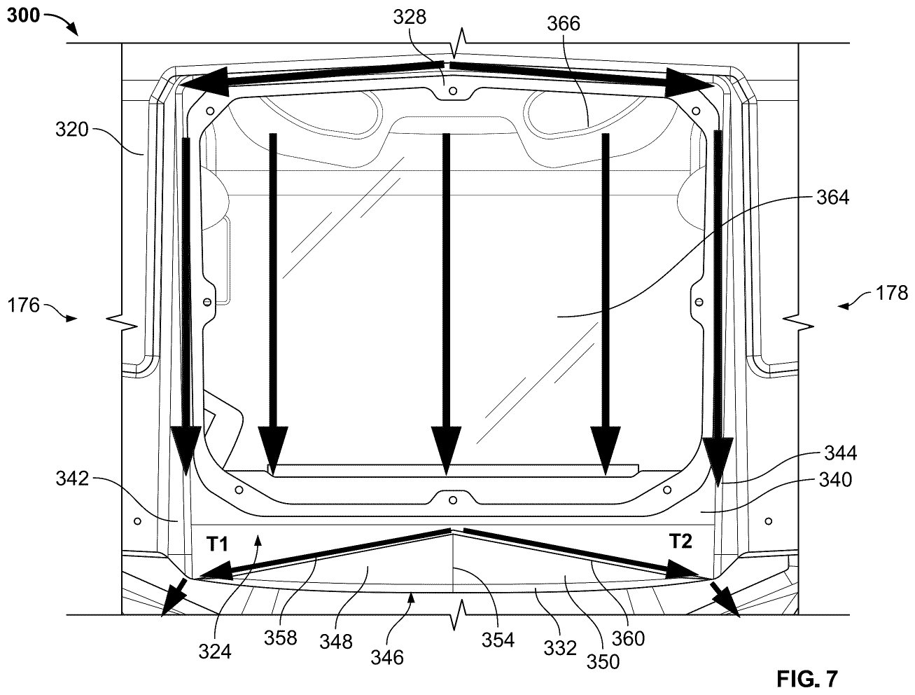

For example, FIGS. 7 and 8 show an illustrative flow pattern of water or other fluid falling onto the cab roof 200 when the utility vehicle 100 is at rest on level ground. The large arrows illustrate the movement of water as it flows across the upper surface 300. As described above, the second planar surface 340 is slanted downward from the first planar surface 320 toward the front end 170. Accordingly, water is directed from the back-most edge 328 of the second planar surface 340 toward the front end 170 of the utility vehicle 100 and travels within the u-shaped channel 324. Further, as the water approaches the raised lip structure 346, the water is directed into the two triangular channels T1 and T2. The water flowing in the channel T1 is directed toward the lateral side 176, and the water flowing in the channel T2 is directed toward the lateral side 178. In some forms, for example, where the upper surface 300 includes a back planar surface that extends from an edge of the first planar portion 320 toward the rear end 174 and is slanted downward as it extends from the edge of the first planar surface 320 toward the rear end 174, water can also be directed off of the top of the cab roof 200 toward the engine compartment 160/rear end 174.

As a result, water and debris is prevented from accumulating on top of the cab roof 200, and in particular, on top of the transparent pane 364. Because water, especially rain water, does not collect on top of the transparent pane 364 and then evaporate, mineral deposits are on top of the transparent pane 364 are reduced or eliminated. The cab roof 200 thus improves the line of sight of the operator of the utility vehicle 100 as well as providing other benefits.

In other embodiments, other configurations are possible. For example, those of skill in the art will recognize, according to the principles and concepts disclosed herein, that various combinations, sub-combinations, and substitutions of the components discussed above can provide appropriate protection for the roof of a utility vehicle cab.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A utility vehicle comprising:
an operator cab having a front end and a back end, the operator cab including a cab roof having an upper surface extending from the front end to the back end; and
the upper surface includes a first planar surface and a recessed portion, the recessed portion including a second planar surface, wherein the second planar surface is positioned at an angle with respect to the first planar surface such that the second planar surface slopes downward and away from the first planar surface as the second planar surface extends from the back end to the front end of the operator cab.

2. The utility vehicle of claim 1, wherein the recessed portion includes an opening and a transparent pane covering the opening, the transparent pane being angled with respect to the first planar surface such that the transparent pane extends downward and away from the first planar surface as the transparent pane extends from the back end to the front end of the operator cab.

3. The utility vehicle of claim 1, wherein the recessed portion forms a u-shaped channel in the upper surface of the cab roof, the u-shaped channel extending to a front-most edge of the upper surface.

4. The utility vehicle of claim 1, wherein the upper surface further includes a back planar surface that extends downward and away from the first planar surface as the back planar surface extends from an edge of the first planar surface toward the back end of the operator cab.

5. The utility vehicle of claim 2, wherein the upper surface further includes a grid structure that separates the opening into a plurality of openings.

6. The utility vehicle of claim 3, wherein the upper surface includes two lateral walls that extend from the first planar surface to the second planar surface to form the sides of the u-shaped channel.

7. The utility vehicle of claim 2, wherein the transparent pane is bonded to a portion of the recessed portion.

8. A utility vehicle comprising:
a vehicle body having a front end and a rear end;
an operator cab, the operator cab including a cab roof having an upper surface; and
the upper surface having a recessed second surface being slanted downward toward the front end such that when the utility vehicle is positioned on a level surface, liquid falling onto the second surface is directed by the second surface toward the front end of the vehicle body.

9. The utility vehicle of claim 8, wherein the second planar surface includes an opening and a transparent pane covers the opening.

10. The utility vehicle of claim 8, wherein the upper surface further includes a first planar surface and a back planar surface, the back planar surface extending from an edge of a first planar surface toward the rear end, the back planar surface being slanted downward as it extends from the edge of the first planar surface toward the rear end such that when the utility vehicle is positioned on a level surface, liquid falling on to the back planar surface is directed toward an engine compartment positioned at the rear end.

11. The utility vehicle of claim 8, wherein an angle between a first planar surface of the upper surface and the second surface is between about 3 degrees to about 10 degrees.

12. The utility vehicle of claim 8, wherein the operator cab includes a front opening and a crossmember at the top of the front opening, the cross member including a length dimension and a width dimension, wherein the ratio of the length dimension to the width dimension is about 7 to about 1 or greater.

13. The utility vehicle of claim 8, wherein the second surface includes a grid structure that is positioned beneath, and adjacent, a transparent pane.

14. A utility vehicle comprising:
a vehicle body having a front end, a back end, and two lateral sides; and
an operator cab roof having an upper surface including a first planar surface and a second planar surface, the second planar surface including a lip on an edge of the second planar surface disposed adjacent the front end of the vehicle body, the lip having a raised center ridge positioned at a centerline of the vehicle body, the centerline extending from the front end to the back end of the vehicle body, the raised center ridge adjoining a plurality of lateral surfaces that are angled downward as the lateral surfaces extend away from the center ridge toward the lateral sides of the vehicle body.

15. The utility vehicle of claim 14, wherein the lip is chamfered toward the front end of the vehicle body.

16. The utility vehicle of claim 14, wherein the lateral surfaces are substantially triangular and share an edge at the raised center ridge.

17. The utility vehicle of claim 14, wherein the second planar surface and a plurality of lateral walls form a u-shaped channel in the upper surface of the cab roof, and at least one of the lateral surfaces and at least one of the plurality of lateral walls together form a triangular channel.

18. The utility vehicle of claim 14, wherein the second planar surface includes an opening, a grid structure, and a transparent pane positioned over the grid structure and covering the opening, the transparent pane being angled with respect to the upper surface such that the transparent pane extends downward and away from the upper surface as the transparent pane extends from the back end to the front end of the vehicle body.

19. The utility vehicle of claim 17, wherein the triangular channel tapers in a direction toward at least one of the lateral sides of the vehicle body and toward the front end of the vehicle body.

20. The utility vehicle of claim 17, further comprising two triangular channels, a first triangular channel formed by a first lateral surface and a first lateral wall and a second triangular channel formed by a second lateral surface and a second lateral wall.
